(19) United States
(12) Patent Application Publication
(10) Pub. No.: US 2011/0259895 A1
(43) Pub. Date: Oct. 27, 2011

(54) INSULATED BOX

(76) Inventors: Martin PARENTEAU, Drummondville (CA); Stéphane MORASSE, Kingsey Falls (CA); Aileen C. Sarmiento, Brampton (CA)

(21) Appl. No.: 13/078,332

(22) Filed: Apr. 1, 2011

Related U.S. Application Data
(63) Continuation-in-part of application No. 11/857,683, filed on Sep. 19, 2007, now abandoned.
(60) Provisional application No. 60/845,512, filed on Sep. 19, 2006.

(51) Int. Cl. B65D 81/38; B32B 38/00; B32B 37/14; B65D 21/00; B32B 37/02

(52) U.S. Cl. 220/592.2; 220/23.87; 156/306.6; 156/83

(57) ABSTRACT

The use of expanded polymers can be at least reduced by using repulpable materials. For instance, insulation characteristics of insulated boxes can be provided by a core of honeycomb repulpable material. Further, the insulation characteristics can be further enhanced by loosely filling cells of the honeycomb structure with particles held in the cells by two skins on opposite faces of the core.

### CROSS-REFERENCE TO RELATED APPLICATIONS

This application is a continuation-in-part of U.S. application Ser. No. 11/857,683, filed Sep. 19, 2007, which claimed priority of U.S. provisional application No. 60/845,512, filed Sep. 19, 2006, the contents of both of which are hereby incorporated by reference.

### BACKGROUND

There remained room for improvement in the field of insulated boxes. In particular, there was a need to reduce the use of expanded polymers in such boxes.

### SUMMARY

The use of expanded polymers can be reduced by using at least some repulpable materials. For instance, insulation characteristics of the insulated boxes can be provided by a core of honeycomb repulpable material. Further, the insulation characteristics can be further enhanced by loosely filling cells of the honeycomb structure with particles held in the cells by two skins on opposite faces of the core.

Such a sandwich-structure can be more valuable to recycle than an all-expanded-polymer panel. It can at least reduce the amount of expanded polymer used in the panel. Any resulting tradeoff in costs or thermal resistance can be acceptable for some applications.

In accordance with one aspect, there is provided a set of insulating panels arranged in a rectangular-prism shape, wherein each one of the insulating panels has a core having a honeycomb structure of repulpable material, the honeycomb structure having an array of cells; two skins sandwiching the core, each one of the two skins being at least one of hand-removable from the core and made of a recyclable material; and a plurality of particles loosely filling the cells; and wherein each one of the insulating panels forms a face of a rectangular-prism shape and has edges in abutment with other ones of the insulating panels.

In accordance with another aspect, there is provided a kit for making an insulated box, the kit comprising a set of six insulating panels, each having a core with a honeycomb structure of repulpable material forming an array of cells and two skins sandwiching the core, and a box in a folded state, wherein the box is sized in a manner that the set of six insulating panels can be arranged in a rectangular-prism shape inside the box when the box is in a deployed state.

In accordance with another aspect, there is provided a process of making an insulating material, the process comprising in sequence: adhering a first skin to a first face of a honeycomb structure having an array of cells; loosely filling the cells with particles through a second face of the honeycomb structure; and adhering a second skin to the second face of the honeycomb structure.

The honeycomb core can have material arranged in a manner to define a regular array of cells shaped hexagonal, square, triangular, or quasi-circular, for instance, depending of the application.

### DESCRIPTION OF THE FIGURES

FIG. 1 is a perspective view of an example of an insulated box made with a plurality of insulating panels;

FIG. 2 is a perspective view of another example of an insulated box made from a kit;

FIG. 3 is a perspective view of an example of an insulating panel;

FIG. 4 is a cross-sectional view taken along lines 4-4 of FIG. 3;

FIG. 5 is a schematic view of a process of making an insulating panel.

### DETAILED DESCRIPTION

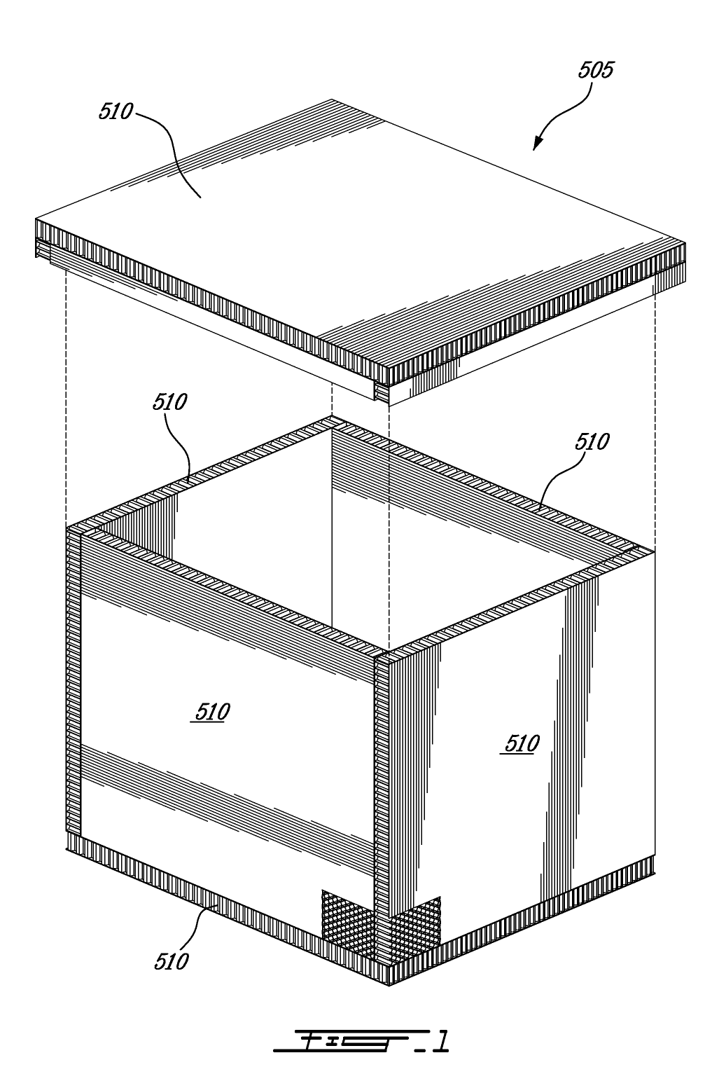

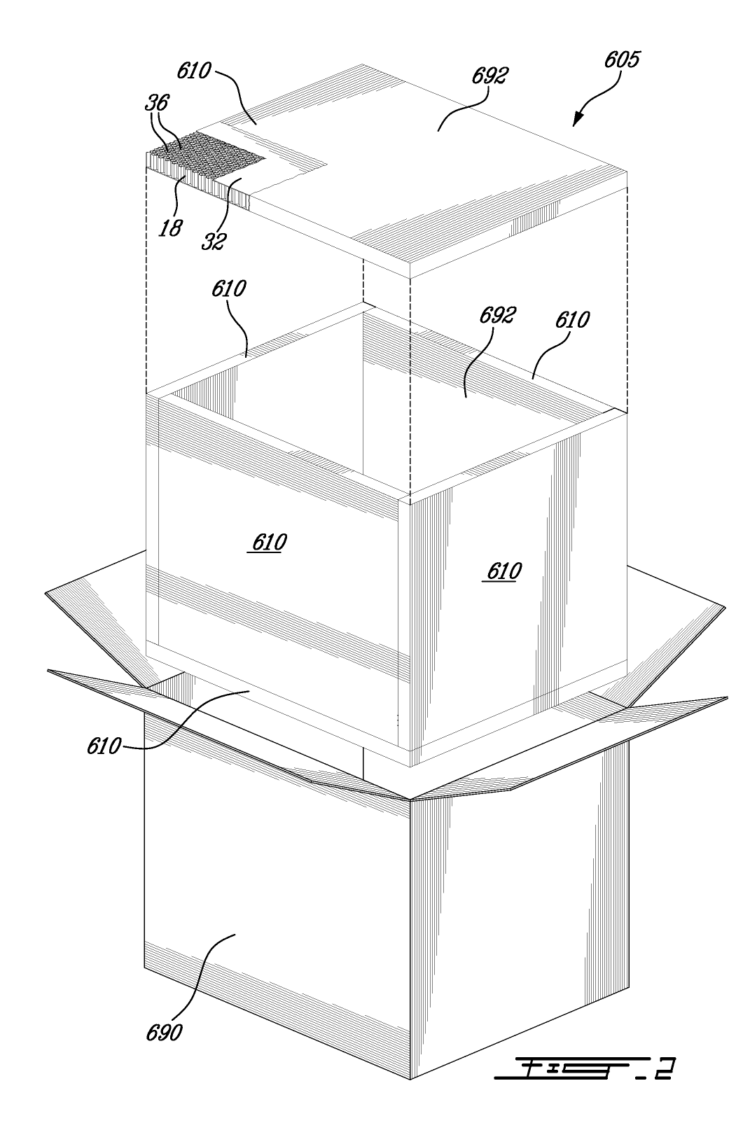

FIG. 1 shows a set of insulating panels 510 arranged in a rectangular prism shape configuration 505. The rectangular prism shape configuration shown can be used alone as a box, with panels connected to one another, or can be used as thermal insulation inside an other box structure, for example (an example of which is shown in FIG. 2).

The configuration is achieved in this case by assembling a plurality of insulating panels 510. The insulating panels 510 can all be cut and assembled. In this case the insulating panels 510 can be held in the rectangular prism shape either by adhering the panels to one another, or by simply abutting the edges of the panels against other panels without adhesive, but by fitting the panels snugly into a box, such as a corrugated cardboard box for instance (shown in FIG. 2), which holds the panels in place. Alternately, the container can include a folded insulating panel. The insulating panel can be made foldable by creating a V-groove in the insulating panel by means such as rolling a V-shaped wheel (cornerwheel) thereinto, for example (not shown).

Further, alternately, a box shape of insulating panels can thus be used as a sleeve, outside a receptacle or box, or can be used inside a receptacle or box made of another material, such as a corrugated cardboard box 690 such as shown in FIG. 2, for instance.

Henceforth, a kit for making an insulating box can be provided using 6 insulating panels 610 and a receptacle or box 690 such as a corrugated cardboard box for instance in a folded state. The dimensions of the box 690 and panels 610 can be selected for the panels to snugly fit inside the box 690 when arranged in the rectangular prism shape, with very little or no free space between the panels and the box.

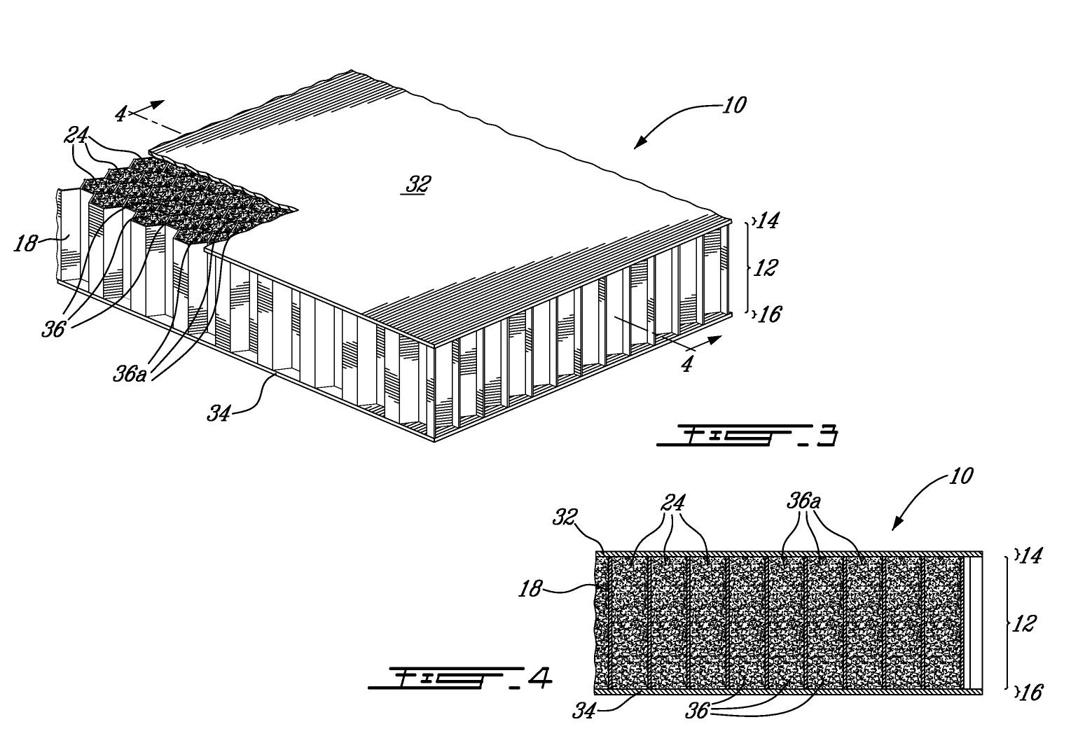

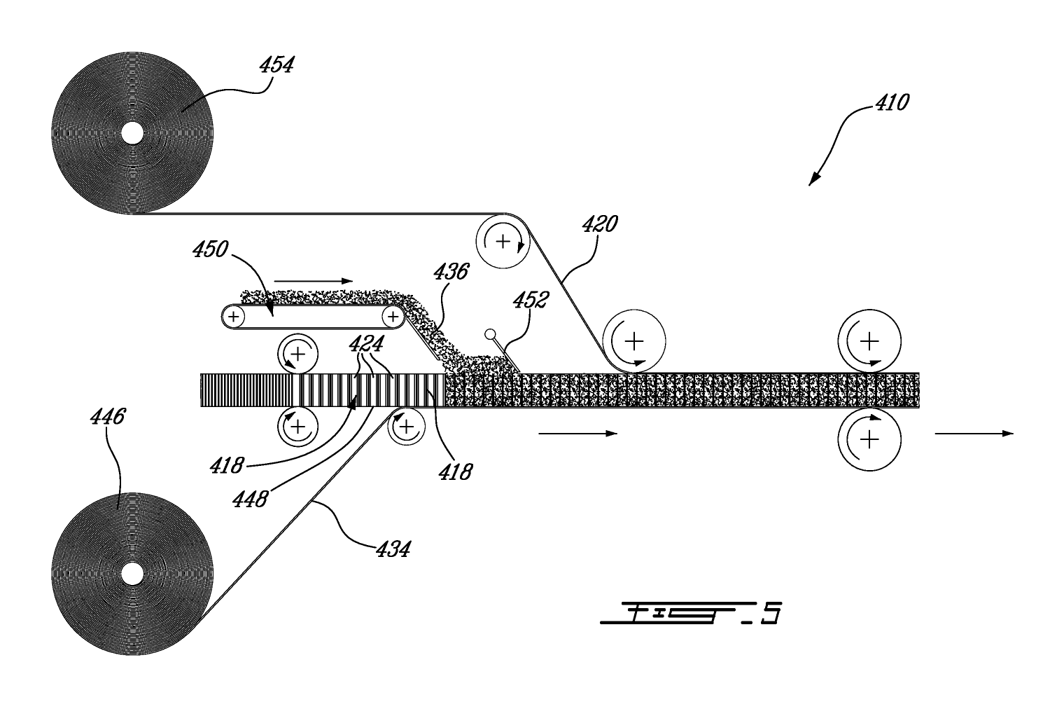

FIGS. 3 and 4 show an example of an insulating panel 10 which can be used. The insulating panel 10 has a sandwich-type structure with a core 12 sandwiched between a first skin 14 and a second skin 16. The core 12 has a hexagonal cell honeycomb structure 18.

One factor which can limit the amount of thermal insulation achieved is natural convection occurring in the cells 24 of the honeycomb structure when the insulating panel is in use. The thermal insulation of a sandwich-structured panel can thus be increased by loosely filling the cells with particles 36, to impede natural convection in the cells. The selected particles can have a low thermal conductivity, to further impede heat transfer which can occur by conduction across the particles.

Henceforth, in this particular embodiment the cells 24 of the honeycomb structure 18 are loosely filled with particles 36. In this instance, the particles are paper shreds 36a, so as to further increase the repulpability of the insulating panel. Shreds of expanded polymer material, which can be obtained from expanded polymer sheet trims for example, or other particles, can be used in alternate embodiments. Using particles in a form, texture, and size which allows them to fall relatively easily into the cells can help assembling the panels. This falling-ability can vary depending on the cell diameter. Particles can otherwise be blown into the cells or fed thereinto using any other suitable process, for example.

In at least some instances where particles are used in the cells, some of the particles can be freed from the cells when the insulating panel is cut to its desired dimensions. The occurrence of free particles is undesirable in certain embodiments. Henceforth, the insulating panels can be wrapped in a wrapping which prevents escaping of the particles. In the example shown in FIG. 2, the insulating panels 610 are shown wrapped in a wrapping 692. In some embodiments, the wrapping can simply be a folded paper sheet material for instance, which can further be coated with a water-resistant layer or covered by a polymer film for instance in embodiments where water-resistance is desired. Alternately, the wrapping can be made of a polymer material, such as polyethylene for instance.

In the embodiment shown, the skins can also be made of a repulpable material so as to further increase the repulpability of the insulating panel. Single linerboard layers 32, 34, or sheets of Kraft paper, can be used to this end, for instance.

It will be understood that if more thermal insulation is desired, one or both of the linerboards 32, 34 can be replaced by a skin having a layer of insulating material, and optionally other layers. An example of insulating materials can include a layer of polymer foam, or a corrugated cardboard layer, for instance.

Many alternate embodiments to the one depicted in FIGS. 3 and 4 are possible. For instance, each skin 14, 16 can have respective layer 20, 22 of an expanded polymer directly adhered to the honeycomb structure 18. Also, one or both of the skins can include more than one layer of insulating material, and/or can include one or more additional layer(s) of non-insulating material. In some instances, it can be advantageous to add a polymer film layer, such as for increasing the resistance of the insulating panel to liquid water, for instance.

In embodiments where the insulating material used in one or both skins is not recyclable, the layer of that insulating material can be selected to be removable by hand, so that once the useful life of the insulating panel ends, the non-recyclable layer of insulating material can be easily removed and discarded, and the remainder of the panel be recycled. Alternately, the layer of insulating material can be designed to be mechanically removed.

Selecting a repulpable material, such as recycled paperboard for instance, as the material for the honeycomb structure 18 can render the insulating panel 10 relatively valuable to recycle, as compared to a full panel of expanded polystyrene for example.

Even if the insulating panel 10 is not recycled, the use of a wood-based honeycomb structure 18 will typically make the insulating panel 10 more biodegradable than a panel having the same thickness. The degradability of any expanded polymers used in the panel, if any, can be enhanced by adding pro-degradant additives during their manufacturing process. Therefore, in applications where there is a focus on the degradability aspect of the insulating panel, an oxo-degradable expanded polymer can be used, such as polystyrene having a chemical additive such as TDPA® for example.

When used in packaging boxes which are designed to contain ice, it can be advantageous that an exposed face of the insulating panel have a surface that is water resistant.

The insulating panel 10 can thus be an interesting substitute to expanded polymer boards. The insulating panel 10 can be used as a material for making insulating packaging such as insulated boxes, for instance.

Turning now to FIG. 5, an example of a process 410 for producing an insulating panel on-line, as a continuous process, is shown. A web of honeycomb material 418 is provided by expanding the honeycomb material from a folded state. A first skin 434 is unrolled from a first roll 446 into a web, and adhered to a first face 448 of the expanded honeycomb web 418. In this example, an optional step of dropping insulating particles 436 in the cells 424 takes place. The insulating particles 436 can be carried by a conveyor 450, for example, and dropped into the upper, open end of the cells 424. A rake 452 or a similar device can be used to move insulating particles 436 from the upper ends of the honeycomb structure 418 to other cells once previous cells are filled. A second, upper skin 420, which can be provided as a web by unrolling from a second roll 454, is then applied to the upper face of the honeycomb structure 418, thereby closing the cells 424, and trapping therein the insulating particles 436. It will be noted here that in embodiments where the step of putting insulating particles in the cells is omitted, both skins can be applied simultaneously. Linerboards and sheets of expanded polymer having a relatively small thickness can both be unrolled from rolls.

In various embodiments, several adhesives can be used to adhere the skins to the core portion and/or to adhere the layers of the skins to one another. For example, water-based adhesives such as polyvinyl alcohol (PVOH), polyvinyl acetate (PVA), acrylic, stamp glue, silicate solutions, and dextrin, can be used. Hot melt adhesives such as polyolefin and ethylene vinyl acetate (EVA) can also be used. Polyurethane can also be used.

In some embodiments, it can be advantageous to use a repulpable adhesive. In other embodiments, it might be desirable to use an adhesive that remains on the faces of the honeycomb structure or an adhesive that bonds very rapidly. In some instances, a pressure-sensitive adhesive can be used. The pressure-sensitive adhesive can be activated by applying pressure on the two components being bonded together and including the adhesive therebetween. Alternately, a polymer layer can be applied between the two components and be activated, to bond the components together by heat or pressure, for example. Simultaneously, the polymer layer can enhance the barrier properties of the resulting insulating panel.

In various embodiments, the honeycomb structure can be made of wood fiber based materials or polymers, for instance. For wood fiber based materials, paperboard, cardboard, kraft paper, recycled paper, medium, chipboard, bleached or not, and the like can be used. It can be made entirely of recycled material. It can be impregnated with a resin to improve its resistance to water, grease or fire, its gas and vapor barrier properties, its non-slip properties, and the like. It can also be treated with a water-based coating or a resin coating.

The skins can include sheets of wood fiber based materials, sheets of expanded polymers including degradable polymers, polymers laminated on a wood fiber based material, polymers laminated between two layers of wood fiber based material, etc. The wood fiber based material layers and polymer layers can be structured (for example corrugated) or substantially flat.

The thickness of the insulating material layer can vary in accordance with specific needs.

It will be understood that the examples described above and illustrated are exemplary only. The scope is indicated by the appended claims.

What is claimed is:

1. A set of insulating panels arranged in a rectangular-prism shape, wherein each one of the insulating panels has a core having a honeycomb structure of repulpable material, the honeycomb structure having an array of cells; two skins sandwiching the core, each one of the two skins being at least one of hand-removable from the core and made of a recyclable material; and a plurality of particles loosely filling the cells; and wherein each one of the insulating panels forms a face of a rectangular-prism shape and has edges in abutment with other ones of the insulating panels.

2. The set of insulating panels of claim 1 wherein the particles are repulpable.

3. The set of insulating panels of claim 1 wherein the particles are shreds.

4. The set of insulating panels of claim 3 wherein the shreds are paper shreds.

5. The set of insulating panels of claim 1 wherein each one of the two skins is made of a repulpable material.

6. The set of insulating panels of claim 1 wherein the insulating panels are individually wrapped in a wrapping.

7. The set of insulating panels of claim 6 wherein the wrapping is of sheet material.

8. The set of insulating panels of claim 7 wherein the sheet material is paper covered by a water-resistant layer.

9. The set of insulating panels of claim 6 wherein the wrapping has a water-resistant outer facing.

10. The set of insulating panels of claim 1 provided inside a box.

11. The set of insulating panels of claim 10 wherein the box is a corrugated cardboard box.

12. The set of insulating panels of claim 10 wherein the set of insulating panels fits snugly inside the box.

13. A kit for making an insulated box, the kit comprising a set of six insulating panels, each having a core with a honeycomb structure of repulpable material forming an array of cells and two skins sandwiching the core, and a box in a folded state, wherein the box is sized in a manner that the set of six insulating panels can be arranged in a rectangular-prism shape inside the box when the box is in a deployed state.

14. The kit of claim 13 wherein the rectangular prism shape snugly fits inside the box when the box is in the deployed state.

15. The kit of claim 13 wherein each one of the insulating panels has a plurality of particles loosely filling the cells.

16. The kit of claim 15 wherein the two skins are made of a repulpable material, and the insulating particles are paper shreds.

17. The kit of claim 15 wherein each one of the insulating panels are individually wrapped in a wrapping.

18. A process of making an insulating material, the process comprising in sequence:
adhering a first skin to a first face of a honeycomb structure having an array of cells;
loosely filling the cells with particles through a second face of the honeycomb structure; and
adhering a second skin to the second face of the honeycomb structure.

19. The process of claim 18 further comprising: expanding the honeycomb structure prior to said applying a first skin; wherein the steps of adhering a first skin, filling the cells, and adhering a second skin are done on-line as a continuous process.

20. The process of claim 19 wherein the step of filling the cells includes dropping the particles onto the second face of the honeycomb structure while the honeycomb structure is being longitudinally moved, and using a fixed-position rake to push particles exceeding filled cells into subsequent cells in the longitudinal movement.
